(19) United States
(12) Patent Application Publication
(10) Pub. No.: US 2015/0134368 A1
(43) Pub. Date: May 14, 2015

(54) METHOD AND APPARATUS FOR MANAGING VEHICLE INSURANCE

(71) Applicant: ELECTRONICS AND TELECOMMUNICATIONS RESEARCH INSTITUTE, Daejeon (KR)

(72) Inventor: Byung Yun Lee, Daejeon (KR)

(73) Assignee: ELECTRONICS AND TELECOMMUNICATIONS RESEARCH INSTITUTE, Daejeon (KR)

(21) Appl. No.: 14/242,937

(22) Filed: Apr. 2, 2014

(30) Foreign Application Priority Data
Nov. 8, 2013 (KR) 10-2013-0135825

(51) Int. Cl. G06Q 40/08

(52) U.S. Cl. CPC G06Q 40/08
USPC 705/4

(57) ABSTRACT

In order to manage vehicle insurance by connecting to a vehicle information collection apparatus that is mounted in a vehicle, by initializing the vehicle information collection apparatus, vehicle driving information including data corresponding to a kind of insurance to which a user of the vehicle subscribes is collected. Thereafter, a safe driving index or an environmentally-friendliness driving index is calculated according to a kind of insurance to which the user subscribes based on the vehicle driving information that is collected from the vehicle information collection apparatus, and insurance to which the user subscribes is managed based on the calculated safe driving index or environmentally-friendliness driving index.

### CROSS-REFERENCE TO RELATED APPLICATION

This application claims priority to and the benefit of Korean Patent Application No. 10-2013-0135825 filed in the Korean Intellectual Property Office on Nov. 8, 2013, the entire contents of which are incorporated herein by reference.

### BACKGROUND OF THE INVENTION

1. Field of the Invention

The present invention relates to a system and method for managing insurance of a vehicle using vehicle driving information.

2. Description of the Related Art

Nowadays, for diagnosis of a vehicle, driving-related data and state information of a vehicle may be extracted through a built-in on board diagnostic (OBD) interface, and this is applied to all vehicles that have been produced after the year 1996. Further, such an OBD apparatus notifies a driver or a mechanic of a problem of a vehicle through an erroneous operation indication lamp of a malfunction indicator lamp (MIL). Further, when the driver drives the vehicle, the OBD apparatus continues to monitor a vehicle state, and when detecting a problem generated in an engine ignition system or an exhaust apparatus, the OBD apparatus operates an erroneous operation indication lamp representing the problem, and until a corresponding problem is solved, the OBD apparatus maintains a turn-on state of the lamp.

Various information that is related to driving of a vehicle is acquired using such an OBD apparatus, and technology that performs vehicle management based on the acquired information has been developed. However, there is no service that provides various information that is related to vehicle driving by connecting it to insurance to which a vehicle driver subscribes.

### SUMMARY OF THE INVENTION

The present invention has been made in an effort to provide a system and method for managing insurance information that is related to a vehicle using vehicle driving information.

An exemplary embodiment of the present invention provides a method of managing vehicle insurance by connecting to a vehicle information collection apparatus that is mounted in a vehicle, the method including: collecting vehicle driving information including data corresponding to a kind of insurance to which a user of the vehicle subscribes by initializing the vehicle information collection apparatus; receiving vehicle driving information that is collected from the vehicle information collection apparatus; calculating a safety driving index or an environmentally-friendliness driving index according to a kind of insurance to which the user subscribes based on the received vehicle driving information; and managing insurance to which the user subscribes based on the calculated safety driving index or environmentally-friendliness driving index.

The collecting of vehicle driving information may include: receiving an initialization request message from the vehicle information collection apparatus; determining a kind of data to collect according to a kind of insurance to which the user of the vehicle subscribes; and generating a terminal initialization message including the determined data kind and transmitting the terminal initialization message to the vehicle information collection apparatus.

The collecting of vehicle driving information may include: receiving an initialization request message including an identification number of the vehicle information collection apparatus that the terminal acquires by communicating with the vehicle information collection apparatus from the terminal of a user of the vehicle; determining a kind of data to collect according to a kind of insurance to which the vehicle user subscribes; and generating a terminal initialization message including the determined data kind and transmitting the terminal initialization message to one of the user terminal and the vehicle information collection apparatus.

The determining of a kind of data may include: determining whether the vehicle driver has subscribed to one of a safety index-based insurance service and an environmentally-friendliness driving index-based insurance service; and determining a data kind to collect according to the determined insurance service.

The initialization request message may include a serial number, which is an identification number of the vehicle information collection apparatus, and a mounting date when the vehicle information collection apparatus is mounted in the vehicle. The terminal initialization message may include a name of the user, vehicle information, a kind of insurance to which the user subscribes, and a kind of vehicle driving information data to collect for corresponding insurance.

The method may further include: when the user subscribes to a safe driving-based insurance service, calculating a first variable, which is a number of sudden accelerations, a second variable, which is a number of sudden braking events, a third variable, which is a number of long time driving events, a fourth variable, which is a number of speed limit violations, and a fifth variable, which is an excess traveling distance based on the vehicle driving information; giving respective different weight values to at least one of the first to fifth variables; and calculating a safe driving index based on the first variable to the fifth variable in which the weight values are given.

In the calculating of a safe driving index, a condition of the safe driving index=A+B+(C×W1)+(D×W2)+(ENV3) may be used, where A is a first variable, B is a second variable, C is a third variable, D is a fourth variable, E is a fifth variable, W1 is a weight value of the first variable, W2 is a weight value of the second variable, and W3 is a weight value of the third variable.

The managing of insurance may include: setting a safe driving index grade based on the calculated safe driving index; and discounting an insurance bill of an insurance service or adding a premium of an insurance bill of an insurance service to which the user subscribes according to the preset safe driving index grade.

The method may further include: when the user subscribes to an environmentally-friendliness driving-based insurance service, calculating a first variable, which is a number of sudden accelerations and a number of sudden starts, a second variable, which is a number of sudden decelerations and a number of sudden braking events, a third variable, which is an idle running time, a fourth variable, which is a total traveling distance, and a fifth variable, which is a carbon dioxide discharge coefficient based on the vehicle driving information; giving respective different weight values to at least one of the first variable to the fifth variable; and calculating an environmentally-friendliness driving index based on the first variable to the fifth variable to which the weight values are given. In the calculating of the environmentally-friendliness driving index, a condition of the environmentally-friendliness driving index=(A′×W1)+(B′×W2′)+(C′×W3′)+(D′×E′×W4′) may be used, where A′ is a first variable, B′ is a second variable, C′ is a third variable, D′ is a fourth variable, E′ is a fifth variable, W1′ is a weight value of the first variable, W2′ is a weight value of the second variable, W3′ is a weight value of the third variable, and W4′ is a weight value of the fourth variable.

The managing of insurance may include: setting an environmentally-friendliness driving index grade based on the calculated environmentally-friendliness driving index; and discounting an insurance bill of an insurance service or adding a premium of an insurance bill of an insurance service to which the user subscribes according to the preset environmentally-friendliness driving index grade.

The vehicle driving information may include at least one of: a driving start time, which is a time at which the vehicle is started by a driver and driving is started; a driving stop time, which is a time at which the vehicle is turned off by the driver; an average speed, which is an average value of speed while the vehicle is being driven; a highest speed of a vehicle while the vehicle is being driven; an overspeed driving time, which is a time when the vehicle exceeds a speed limit that is determined for a service while the vehicle is being driven; a long time driving time, which is a driving time that exceeds a long time driving time that is determined for the service while the vehicle is being driven; a driving distance, which is a total distance while the vehicle is being driven in one session; a number of sudden starts, which is the number of times the vehicle accelerates at a rate of speed of a preset value or more when the vehicle starts from a stop; a number of sudden braking events, which is the number of times the vehicle decelerates at a rate of speed of a preset value or more while the driver uses a brake; a number of sudden accelerations, which is the number of times the vehicle suddenly accelerates at a rate of speed of a preset value or more while the vehicle is being driven; a brake use time, which is a time during which the brake is used while the vehicle is being driven; and global positioning system (GPS) information representing a history of GPS values of a region the vehicle moves in while it is being driven.

Another embodiment of the present invention provides a system that manages vehicle insurance by connecting to a vehicle information collection apparatus that is mounted in a vehicle, the system including: a customer insurance information management unit that manages information about insurance to which a user subscribes, wherein the information includes information about an insurance kind including a driving-based insurance service and an environmentally-friendliness driving-based insurance service; an initialization processor that enables collection of vehicle driving information including data corresponding to a kind of insurance to which the vehicle user subscribes by initializing the vehicle information collection apparatus according to a received initialization request message; a vehicle driving information receiving unit that receives vehicle driving information that is collected from the vehicle information collection apparatus; a safety driving index calculation unit that calculates a safety driving index according to a kind of insurance to which the user subscribes based on the received vehicle driving information; and a safety driving index calculation unit that calculates an environmentally-friendliness driving index according to a kind of insurance to which the user subscribes based on the received vehicle driving information.

The initialization processor may determine a kind of data to collect according to a kind of insurance to which a user of the vehicle subscribes, generate a terminal initialization message including a kind of the determined data, and transmit the terminal initialization message to the vehicle information collection apparatus, when receiving the initialization request message.

The safety driving index calculation unit may use a condition of the safety driving index=A+B+(C×W1)+(D×W2)+(ENV3), where A is a first variable, which is a number of sudden accelerations, B is a second variable, which is a number of sudden braking events, C is a third variable, which is a number of long time driving events, D is a fourth variable, which is a number of speed limit violations, E is a fifth variable, which is an excess traveling distance, W1 is a weight value of the first variable, W2 is a weight value of the second variable, and W3 is a weight value of the third variable.

The environmentally-friendliness driving index calculation unit may use a condition of the environmentally-friendliness driving index=(A′×W1′)+(B′×W2′)+(C′×W3′)+(D′×E′×W4′), where A′ is a first variable, B′ is a second variable, C′ is a third variable, D′ is a fourth variable, E′ is a fifth variable, W1′ is a weight value of the first variable, W2′ is a weight value of the second variable, W3′ is a weight value of the third variable, and W4′ is a weight value of the fourth variable. The safe driving index calculation unit may set a safe driving index grade based on the calculated safe driving index and according to the preset safe driving index grades and may discount an insurance bill of an insurance service or add a premium of an insurance bill of an insurance service to which the user subscribes according to the preset safe driving index grade, and the environmentally-friendliness driving index calculation unit may set an environmentally-friendliness driving index grade based on the calculated environmentally-friendliness driving index and may discount an insurance bill of an insurance service or add a premium of an insurance bill of an insurance service to which the user subscribes according to the preset environmentally-friendliness driving index grade.

### BRIEF DESCRIPTION OF THE DRAWINGS

FIG. 1 is a diagram illustrating a structure of a vehicle insurance management system using vehicle driving information according to an exemplary embodiment of the present invention.

FIG. 2 is a block diagram illustrating a structure of an insurance management server according to an exemplary embodiment of the present invention.

FIG. 3 is a flowchart illustrating a process of initializing a vehicle information collection apparatus in an insurance management method according to an exemplary embodiment of the present invention.

FIG. 4 is a flowchart illustrating another process of initializing a vehicle information collection apparatus in an insurance management method according to an exemplary embodiment of the present invention.

FIGS. 5A and 5B are flowcharts illustrating a process of calculating a safe driving index based on vehicle driving information in an insurance management method according to an exemplary embodiment of the present invention.

FIGS. 6A and 6B are flowcharts illustrating a process of calculating an environmentally-friendliness driving index based on vehicle driving information in an insurance management method according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification, unless explicitly described to the contrary, the word “comprise” and variations such as “comprises” or “comprising” will be understood to imply the inclusion of stated elements but not the exclusion of any other elements.

Hereinafter, a system and method for managing vehicle insurance using vehicle driving information according to an exemplary embodiment of the present invention will be described with reference to the drawings.

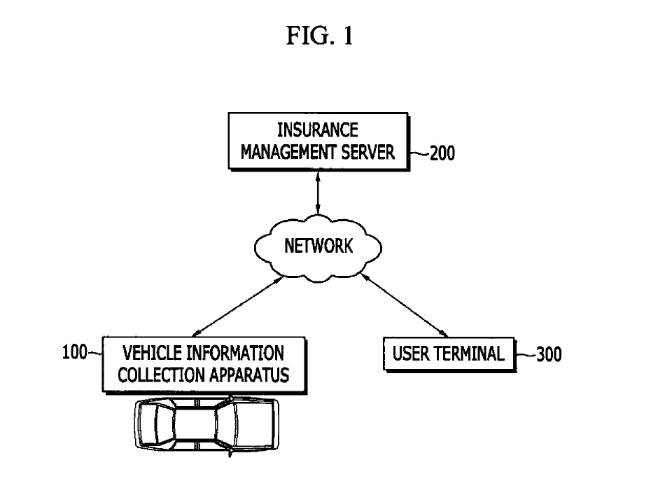

FIG. 1 is a diagram illustrating a structure of a vehicle insurance management system using vehicle driving information according to an exemplary embodiment of the present invention.

As shown in FIG. 1, a vehicle insurance management system using vehicle driving information according to an exemplary embodiment of the present invention includes a vehicle information collection apparatus (for better comprehension and ease of description, representative reference numeral “100” is given thereto) that is installed in each vehicle to collect vehicle driving information, and an insurance management server 200 that performs vehicle information management and vehicle insurance management based on vehicle driving information that is collected in each vehicle information collection apparatus 100 and that provides a vehicle driving information-based insurance service. Further, a user terminal 300 may communicate with the insurance management server 200 and the vehicle information collection apparatus 100.

The vehicle information collection apparatus 100 collects data about driving information of a vehicle and provides the data to the information management server 200. The vehicle information collection apparatus 100 is mounted, for example, in a lower portion of the vehicle to collect vehicle driving information, and transmits the collected vehicle driving information to the insurance management server 200.

The vehicle information collection apparatus 100 collects, generates, stores, and manages data necessary for a vehicle driving information-based insurance service, such as mileage, day of the week, environmentally-friendliness, and safe driving. Further, the vehicle information collection apparatus 100 may summarize and store the collected data. Data that is collected in the vehicle information collection apparatus 100 in order to provide a vehicle driving information-based insurance service is shown in Table 1.

TABLE 1

| | Collected data | Collected data type |
|---|---|---|
| Vehicle | Driving start time | YYYYMMDDHH24MMSS |
| driving | Driving stop time | YYYYMMDDHH24MMSS |
| informa- | Average speed | Speed (km/h) |
| tion | Maximum speed | Speed (km/h) |
| | Overspeed driving time | Cumulative time |
| | Long time driving | Cumulative time |
| | Driving distance | Meter (M) unit |
| | Number of sudden starts | Cumulative number |
| | Number of sudden braking | Cumulative number |
| | events | |
| | Number of sudden | Cumulative number |
| | accelerations | |
| | Number of sudden | Cumulative number |
| | decelerations | |
| | Brake use time | YYYYMMDDHH24MMSS |
| | GPS information | Longitude |
| | | Latitude |
| | | Time |

Vehicle driving information that is collected in the vehicle information collection apparatus 100 includes a driving start time, a driving stop time, an average speed, a maximum velocity, an overspeed driving time, a long distance driving time, a driving distance, a number of sudden starts, a number of sudden braking events, a number of sudden accelerations, a number of sudden decelerations, a brake use time, and global positioning system (GPS) information.

The driving start time is a time at which a vehicle is started by a driver and driving is started, and may be represented in a form of year, month, day, hour, minute, and second. The driving stop time is a time at which a vehicle is turned off by a driver, and may be represented in a form of year, month, day, hour, minute, and second.

The average speed is an average value of speed while the vehicle is being driven, and the maximum speed is a highest speed value while the vehicle being driven. The average speed and the maximum speed may be represented by km/h.

The overspeed driving time is a time during which a vehicle exceeds the speed limit that is determined for a service while the vehicle is being driven, and may be represented in a form of hour, minute, and second.

The long time driving time is a time during which a vehicle is driven while exceeding a long time driving time that is determined for a service while the vehicle is being driven in one session, and may be represented in a form of hour, minute, and second. Here, the long time driving time that is determined for a service may be two hours.

The driving distance is a total distance covered while the vehicle is being driven in one session, and may be represented in a meter unit.

The number of sudden starts is a number of times a vehicle accelerates at a rate of a preset value or more while the vehicle is being driven. Here, the number of sudden starts may be the number of times a vehicle accelerates at a rate of 11 km/h or more per second after starting from 0 km/h. The number of sudden braking events is the number of times a vehicle decelerates at a rate of a preset value or more while the vehicle is being driven. Here, the number of sudden braking events may be the number of times a vehicle decelerates at a rate of 11 km/h or more per second using a brake. The number of sudden accelerations is a number of times a vehicle accelerates at a rate of a preset value or more while the vehicle is being driven. Here, the number of sudden accelerations may be the number of times a vehicle accelerates at a rate of 11 km/h or more per second. The number of sudden decelerations is a number of times a vehicle decelerates at a rate of a preset value or more while the vehicle is being driven. Here, the number of sudden decelerations may be the number of times a vehicle decelerates at a rate of 7.5 km/h or more per second. The number of sudden starts, the number of sudden braking events, the number of sudden accelerations, and the number of sudden decelerations may be measured according to a reference that is determined by the Korean Ministry of Land, Infrastructure and Transport.

The brake use time is a time during which a brake is used while a vehicle is being driven, and may be used as an auxiliary index for sudden braking or accident determination.

GPS information represents a history of GPS values of a region in which a vehicle moves while being driven. The GPS information may be stored in a predetermined measurement unit, for example, in a unit of 10 minutes, and may be represented with longitude, latitude, and time information.

The vehicle information collection apparatus 100 may collect the foregoing vehicle driving information based on technology that is already known in the art, and may be an apparatus that collects vehicle information through, for example, an OBD interface.

The vehicle information collection apparatus 100 collects and stores vehicle driving information and transmits the stored vehicle driving information to the insurance management server 200. For example, the vehicle information collection apparatus 100 may transmit the stored vehicle driving information to the insurance management server 200 at a predetermined time point, according to a request from an insurance management server, or according to a user request. Here, the vehicle information collection apparatus 100 may summarize, store, manage, and transmit data corresponding to the vehicle driving information.

The insurance management server 200 provides a vehicle driving information-based insurance service based on vehicle driving information that is provided from the vehicle information collection apparatus 100.

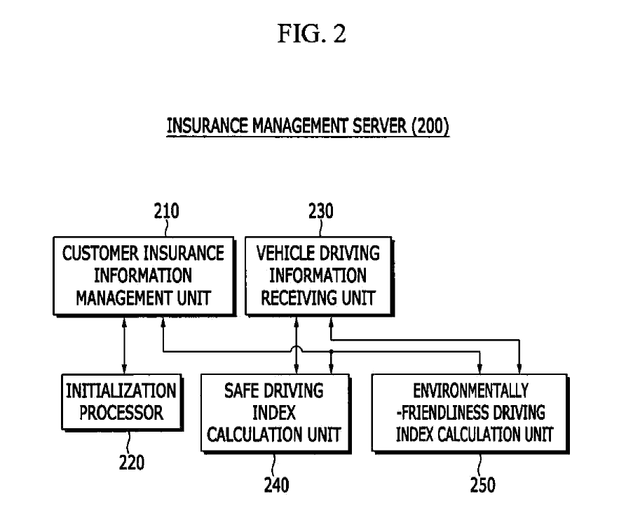

FIG. 2 is a block diagram illustrating a structure of an insurance management server according to an exemplary embodiment of the present invention.

As shown in FIG. 2, the insurance management server 200 according to an exemplary embodiment of the present invention includes a customer insurance information management unit 210, an initialization processor 220, a vehicle driving information receiving unit 230, a safe driving index calculation unit 240, and an environmentally-friendliness driving index calculation unit 250.

The customer insurance information management unit 210 manages information about insurance to which a user subscribes. The customer insurance information management unit 210 may provide insurance related in information to support enabling a user to subscribe to desired insurance, and receive and process information about insurance to which the user subscribes from a server of an insurance company.

The insurance-related information includes a name of a user who subscribes to insurance, vehicle information, and an insurance kind. The vehicle information includes a vehicle identification number, a vehicle model, and a model year. The insurance-related information may be matched to an intrinsic identification number that is given to a vehicle information collection apparatus that is provided to a user of a vehicle that subscribes to insurance. Further, the insurance kind includes a safe driving-based insurance service and an environmentally-friendliness driving-based insurance service according to an exemplary embodiment of the present invention, and may further include an insurance service based on mileage and day of the week.

The initialization processor 220 receives an initialization request message that is transmitted from the vehicle information collection apparatus 100, and when the initialization request message is transmitted from the vehicle information collection apparatus that is mounted in an insured vehicle based on information that is included in the received message, the initialization processor 220 generates terminal initialization information and performs an initialization procedure of the vehicle information collection apparatus 100 based on the terminal initialization information, thereby enabling the vehicle information collection apparatus 100 to collect vehicle driving information. Here, the terminal initialization information includes a customer name, vehicle information, an insurance kind, and a kind of data that is included in the vehicle driving information to collect according to corresponding insurance. The initialization processor 220 may provide an application for initialization of the vehicle information collection apparatus to the user terminal 300.

The vehicle driving information receiving unit 230 receives vehicle driving information from the vehicle information collection apparatus 100.

The safe driving index calculation unit 240 calculates a safe driving index based on the received vehicle driving information, and sets a safe driving index grade according to the calculated safe driving index. Safe driving index calculation and grade setting will be described in detail later.

The environmentally-friendliness driving index calculation unit 250 calculates an environmentally-friendliness driving index based on the received vehicle driving information, and sets an environmentally-friendliness driving index grade according to the calculated environmentally-friendliness driving index. Environmentally-friendliness driving index calculation and grade setting will be described in detail later.

Hereinafter, an insurance information management method according to an exemplary embodiment of the present invention based on a system that is formed with such a structure will be described.

A user who wants to subscribe to insurance determines driving information-based insurance related information (e.g., insurance terms) according to an exemplary embodiment of the present invention, and subscribes to insurance through a home page of an insurance company. In this case, the user may select and subscribe to a safe driving-based insurance service or an environmentally-friendliness driving-based insurance service. The insurance company stores customer information (name, model, model year) and driving information-based insurance related information to which a customer subscribes to an insurance management server. The vehicle information collection apparatus 100 for providing a driving information-based insurance service is provided to a customer. Accordingly, the vehicle information collection apparatus 100 is mounted in the customers vehicle to collect driving information of a corresponding vehicle. Here, the user may have access to an insurance company home page through a home page that provides a rental car service, and may subscribe to vehicle driving information-based insurance (safe driving or environmentally-friendliness driving-based insurance service).

The insurance management server 200 may be a server that an insurance company operates, and may be a server that is operated by an insurance relay system that a service provides by connecting to a plurality of insurance companies. The insurance management server 200 may receive information of an insured customer from each insurance company or another system that provides an insurance subscription service, and may provide a vehicle driving information-based insurance service according to an exemplary embodiment of the present invention.

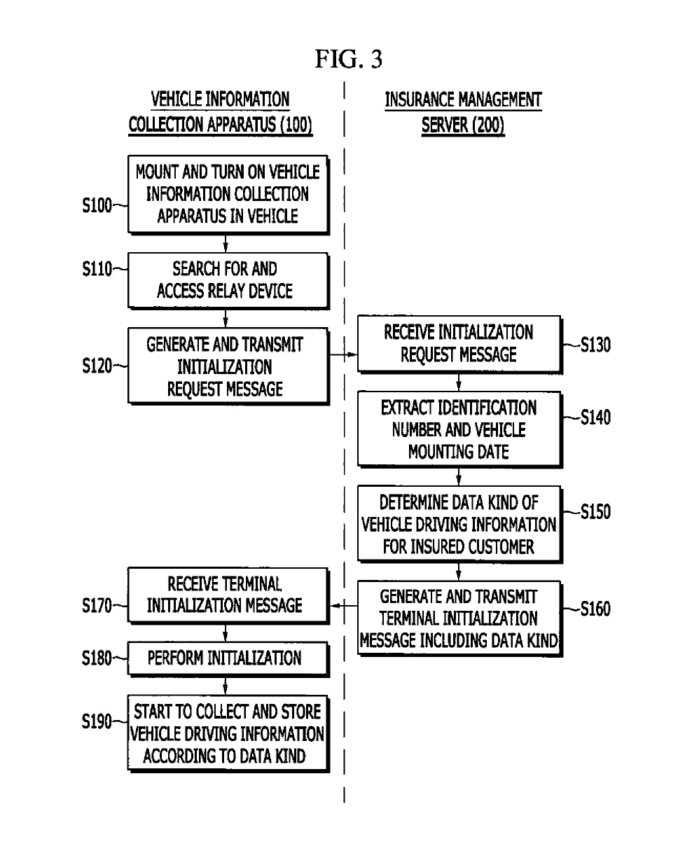

FIG. 3 is a flowchart illustrating a process of initializing a vehicle information collection apparatus in an insurance management method according to an exemplary embodiment of the present invention.

When an insured user, i.e., a customer, mounts the vehicle information collection apparatus 100 in a vehicle and turns it on (S100), the vehicle information collection apparatus 100 searches for a relay device for communication through a network (S110). For example, when an OBD terminal of the vehicle and the vehicle information collection apparatus 100 are connected and power is applied, the vehicle information collection apparatus 100 searches for a relay device, i.e., an access point (AP).

When the relay device is found and is available, the vehicle information collection apparatus 100 generates an initialization request message using an address and port information of a previously defined insurance management server, and transmits the initialization request message to the insurance management server 200 through the relay device (S120). The vehicle information collection apparatus 100 generates an initialization request message including a serial number, which is an identification number thereof, and a date that it is mounted in the vehicle, and transmits the initialization request message to the insurance management server 200.

When the insurance management server 200 receives an initialization request message from the vehicle information collection apparatus 100 in an initialization request reception standby state (S130), the insurance management server 200 extracts an identification number and a vehicle mounting date of the vehicle information collection apparatus 100 from the received initialization request message (S140). The insurance management server 200 compares the extracted identification number with information that is stored at the customer insurance information management unit 210, and determines whether the vehicle information collection apparatus 100 is a vehicle information collection apparatus that is provided to an insured customer.

If the vehicle information collection apparatus 100 is one that is provided to an insured customer, the insurance management server 200 determines a data kind of vehicle driving information to collect based on customer information and insurance related information of insurance to which a corresponding customer subscribes (S150). For example, in a case in which a customer is subscribed to a safe driving-based insurance service and in a case in which a customer is subscribed to an environmentally-friendliness driving-based insurance service, a data kind that should be collected may be different. The insurance management server 200 transmits a terminal initialization message including a kind of determined data, a customer name, vehicle information, and an insured insurance kind to the vehicle information collection apparatus 100 (S160).

The vehicle information collection apparatus 100 receives the terminal initialization message from the insurance management server 200 (S170), extracts a customer name, vehicle information, an insured insurance kind, and a kind of vehicle driving information data to collect for corresponding insurance from the received terminal initialization message, and thus performs initialization of the vehicle information collection apparatus 100 (S180). When performing initialization, initialization of data to collect among vehicle driving information may be performed.

When the initialization procedure is complete, the vehicle information collection apparatus 100 starts to collect data that should be collected among vehicle driving information, and stores the collected data (S190). The vehicle information collection apparatus 100 collects vehicle driving information by connecting to an OBD apparatus of the vehicle, and the OBD apparatus is already known technology and thus a detailed description thereof will be omitted.

In a foregoing initialization procedure, the vehicle information collection apparatus 100 directly transmits an initialization request message to the insurance management server 200 and performs an initialization procedure, but the user may request initialization of the vehicle information collection apparatus 100 to the insurance management server 200 using the user terminal 300.

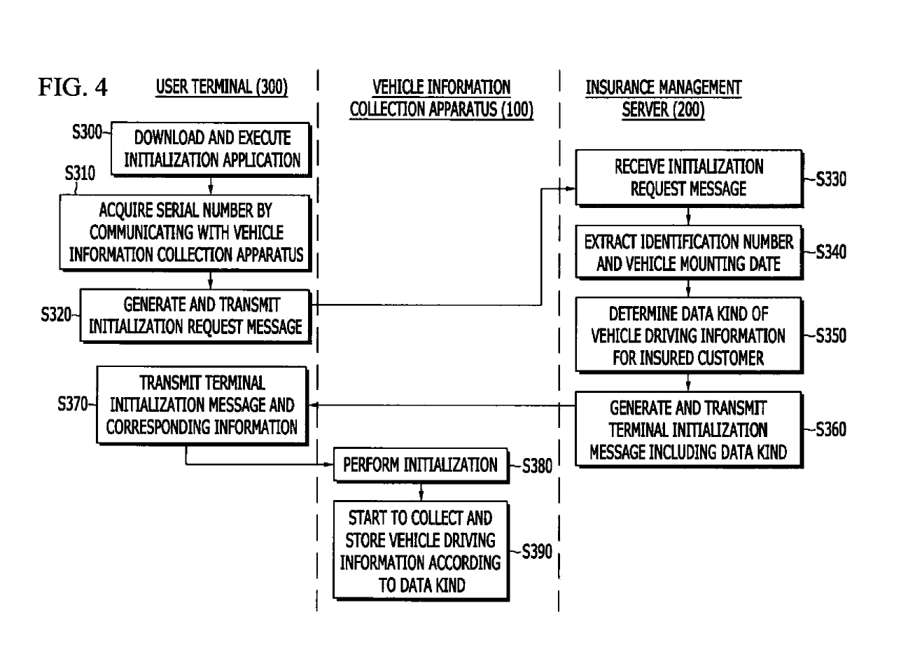

FIG. 4 is a flowchart illustrating another process of initializing a vehicle information collection apparatus in an insurance management method according to an exemplary embodiment of the present invention.

As shown in FIG. 4, in order for a customer to mount the vehicle information collection apparatus 100 in the vehicle and to initialize the vehicle information collection apparatus 100, the customer downloads and executes an initialization application (so-called App) that the insurance management server 200 provides using the user terminal 300 (S300). When the initialization application is executed in the user terminal 300 and the customer selects a command that searches for the vehicle information collection apparatus 100, the user terminal 300 attempts connection to the vehicle information collection apparatus 100 using Bluetooth communication according to the control of the initialization application.

Thereafter, when the user terminal 300 is mounted in the vehicle, when the vehicle information collection apparatus 100 to which power is supplied is found, and when communication is connected, the user terminal 300 receives and stores a serial number, which is an identification number of the vehicle information collection apparatus 100, from the vehicle information collection apparatus 100 and completes pairing (S310).

The user terminal 300 generates an initialization request message including an identification number and a mounting date that are received from the vehicle information collection apparatus 100, and requests initialization of the vehicle information collection apparatus 100 while transmitting the initialization request message to the insurance management server 200 (S320).

Thereafter, as described above, the insurance management server 200 extracts and analyzes information from the received initialization request message, and when the initialization request is one for a vehicle information collection apparatus of an insured customer, the insurance management server 200 determines a data kind of vehicle driving information to collect based on insurance related information and customer information, and transmits a terminal initialization message including the determined data kind, a customer name, vehicle information, and an insured insurance kind to the user terminal 300 (S330-S360). Here, the insurance management server 200 searches for the customer insurance information management unit 210 based on the collected customer information, and determines a kind of insurance to which the customer subscribes. If insurance to which a customer subscribes is related to a safe driving index, the insurance management server 200 determines to collect data about the number of sudden accelerations, the number of sudden braking events, the number of long time driving sessions, the number of speed limit violations, and an excess traveling distance per unit time. If insurance to which a customer subscribes is related to an environmentally-friendliness driving index, the insurance management server 200 determines to collect data about the number of sudden accelerations or the number of sudden starts, the number of sudden decelerations or the number of sudden stops, an idle running occurrence time, a total traveling distance, and carbon discharge amount data. In this way, the insurance management server 200 transmits a message including information of data that is determined to collect to the user terminal 300.

The user terminal 300 transmits information that is included in the terminal initialization message to the vehicle information collection apparatus 100 (S370), and the vehicle information collection apparatus 100 performs initialization according to information that is included in the terminal initialization message and starts to collect the vehicle driving information (S380 and S390). At step S360, the insurance management server 200 may directly transmit the terminal initialization message to the vehicle information collection apparatus 100 instead of transmitting it to the user terminal 300.

Hereinafter, in an insurance management method according to an exemplary embodiment of the present invention, a process of providing a related service based on the collected vehicle driving information will be described.

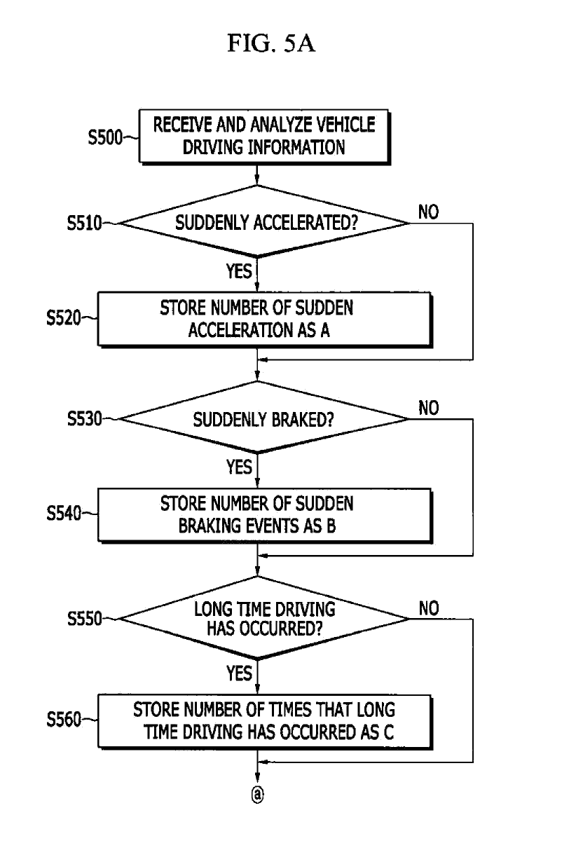

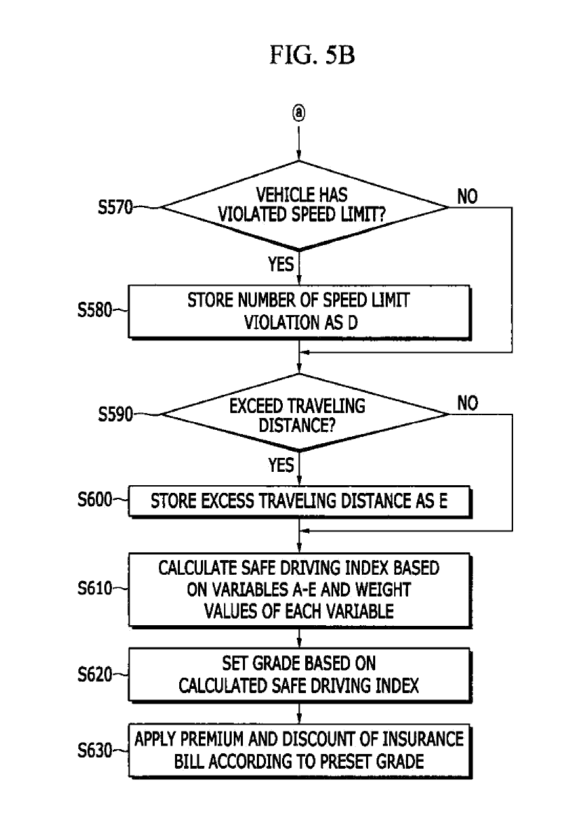

FIGS. 5A and 5B are flowcharts illustrating a process of calculating a safe driving index based on vehicle driving information in an insurance management method according to an exemplary embodiment of the present invention.

As shown in FIGS. 5A and 5B, the insurance management server 200 receives vehicle driving information from the vehicle information collection apparatus 100, and calculates a safe driving index based on the vehicle driving information. Particularly, the insurance management server 200 determines a kind of insurance service to which a customer subscribes based on customer information and insurance-related information, and when a corresponding customer subscribes to a safe driving-based insurance service, the insurance management server 200 calculates a safe driving index.

The insurance management server 200 analyzes the collected vehicle driving information and calculates a safe driving index that is expressed in insurance terms (S500), The insurance management server 200 uses information that occurs within a predetermined period (e.g., 1 week or 1 month) according to insurance terms that a customer sets when subscribing to insurance as vehicle driving information.

Specifically, the insurance management server 200 determines whether the customer's vehicle has been suddenly accelerated within a preset predetermined period based on collected vehicle driving information, and if the customer's vehicle has been suddenly accelerated within a preset predetermined period based on collected vehicle driving information, the insurance management server 200 stores the number of sudden accelerations as a first variable A (S510 and S520). The insurance management server 200 determines whether the customers vehicle has been suddenly braked within a predetermined period, and if so, i.e., when the customer's vehicle has decelerated by a predetermined rate of 11 km/h or more while using a brake, the insurance management server 200 stores the number of sudden braking events in which such a case has occurred as a second variable B (S530 and S540).

The insurance management server 200 determines whether the vehicle has been continuously driven for a predetermined time, for example, two hours or more, and if so, the insurance management server 200 stores the number of times that long time driving has occurred as a third variable C (S550 and S560). In this case, the insurance management server 200 may determine whether long time driving has occurred and the number of times thereof based on a long time driving time that is included in the vehicle driving information.

The insurance management server 200 determines whether the vehicle has violated the speed limit (S570), and if so, the insurance management server 200 stores the number of speed limit violations as a fourth variable D (S580). In this case, the insurance management server 200 may determine whether overspeeding driving has occurred and the number of times thereof based on an overspeeding driving time that is included in vehicle driving information.

The insurance management server 200 determines whether a traveling distance per unit time exceeds a traveling distance that is defined in insurance terms (S590), and if so, the insurance management server 200 stores an excess traveling distance as a fifth variable E (S600). In this case, an excess traveling distance may be calculated based on a driving distance that is included in the vehicle driving information.

As described above, when values of first to fifth variables A-E are acquired based on the collected vehicle driving information, the insurance management server 200 calculates a safe driving index based on the first to fifth variables and weight values W1, W2, W3, W4, and W5 that are defined by an insurance company (S610).

A safe driving index according to an exemplary embodiment of the present invention may be calculated as follows.

safety driving index=A+B+(C×W1)+(D×W2)+(ENV3) (Equation 1)

Herein, A represents the number of sudden accelerations as a first variable, B represents the number of sudden braking events as a second variable, C represents the number of long time driving events as a third variable, D represents the number of speed limit violations as a fourth variable, and E represents an excess traveling distance as a fifth variable. For example, a weight value may be given as W1=02, W2=0.6, and W3=0.2.

As described above, values of first to fifth variables A-E for calculating a safe driving index are acquired based on vehicle driving information, and a safe driving index is calculated as in Equation 1 using preset weight values W1, W2, W3, W4, and W5 according to terms of insurance to which a customer subscribes.

Thereafter, the insurance management server 200 sets a safe driving index grade based on the calculated safe driving index (S620).

The safe driving index is a relative value of collected and analyzed vehicle driving information that is related to safety and is collected from the vehicle information collection apparatus 100, and reflects a weight value that an insurance company provides, and thus in an exemplary embodiment of the present invention, a safe driving index range is defined and a grade is set according to the safe driving index range. For example, in a safe driving index, a grade of 1 to 10 is set according to a minimum value and a maximum value thereof, and a grade of the calculated safe driving index is determined and set.

Thereafter, the insurance management server 200 applies a premium or discount to an insurance bill according to a safe driving index grade corresponding to a customer (S630). For example, as the safe driving index grade advances when it represents that safe driving is not performed, if the safe driving index grade is grade 1, a 10% discount of an insurance bill may be applied, and if the safe driving index grade is grade 3, a 7% discount of an insurance bill may be applied, while if the safe driving index grade is grade 5, a 5% discount of an insurance bill may be applied. However, if the safe driving index grade is grade 6, a 5% premium of an insurance bill may be applied, and if the safe driving index grade is grade 8, a 7% premium of an insurance bill may be applied, while if the safe driving index grade is grade 10, a 10% premium of an insurance bill may be applied.

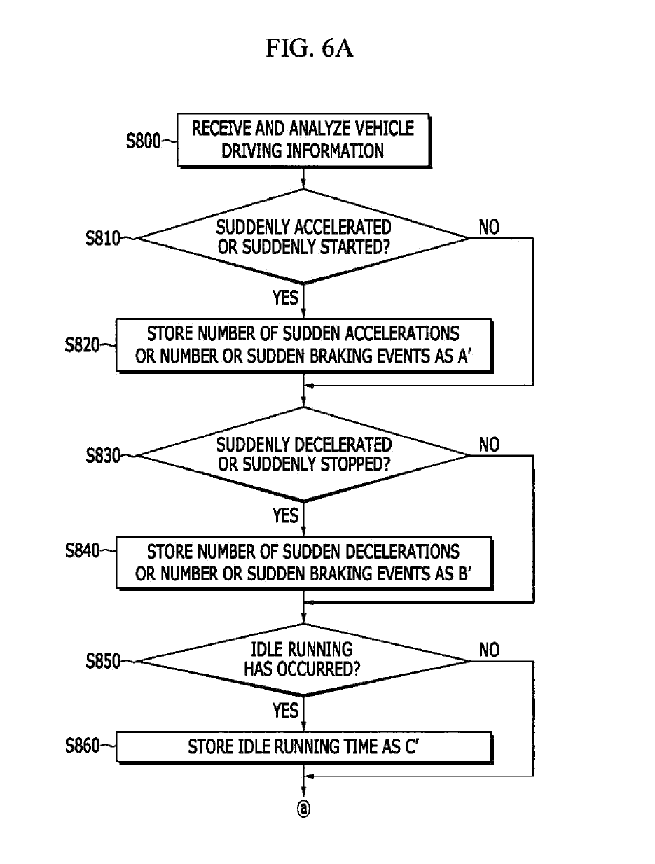

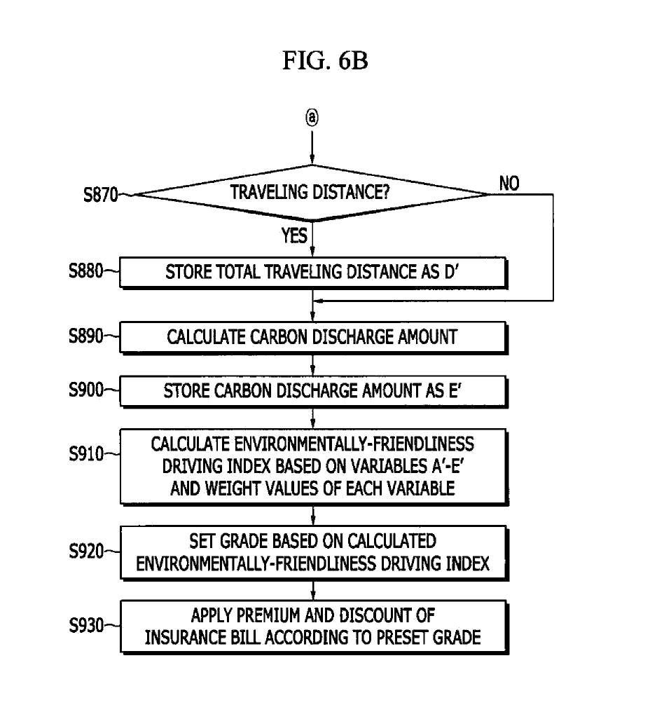

FIGS. 6A and 6B are flowcharts illustrating a process of calculating an environmentally-friendliness driving index based on vehicle driving information in an insurance management method according to an exemplary embodiment of the present invention.

As shown in FIGS. 6A and 6B, the insurance management server 200 receives vehicle driving information from the vehicle information collection apparatus 100 and calculates an environmentally-friendliness driving index based on the vehicle driving information. Particularly, the insurance management server 200 determines a kind of an insurance service to which a customer subscribes based on customer information and insurance related information, and when a corresponding customer subscribes to an environmentally-friendliness driving-based insurance service, the insurance management server 200 calculates a safe driving index.

The insurance management server 200 calculates an environmentally-friendliness driving index that is expressed in insurance terms by analyzing collected vehicle driving information (S800). The insurance management server 200 uses information that occurs within a predetermined period (e.g., 1 week or 1 month) according to insurance terms that a customer sets when subscribing to insurance as vehicle driving information.

Specifically, the insurance management server 200 determines whether the customer's vehicle has been suddenly accelerated or has been suddenly started within a preset predetermined period based on collected vehicle driving information, and if so, the insurance management server 200 stores the number of sudden accelerations or the number of sudden starts as a first variable A′ (S810, S820). The insurance management server 200 determines whether the customer's vehicle has been suddenly decelerated or has been suddenly stopped within a predetermined period based on the collected vehicle driving information, and if so, the insurance management server 200 stores the number of sudden decelerations or the number of sudden braking events as a second variable B′ (S830, S840).

The insurance management server 200 determines whether a time at which idle running of the vehicle has occurred exists (8850), and if so, the insurance management server 200 stores an idle running occurrence time as a third variable C′ (S860). Here, when RPM of the vehicle is 150 and a speed is 0 from the vehicle driving information, it is determined that idle running has occurred.

The insurance management server 200 determines whether a traveling distance of the vehicle exists (S870), and if so, the insurance management server 200 calculates a total traveling distance of the vehicle for a predetermined time and stores a value thereof as a fourth variable D′ (S880).

Further, the insurance management server 200 calculates a carbon discharge amount based on vehicle driving information and stores a value thereof as a fifth variable E′ (S890 and S900). A carbon discharge amount generating while driving the vehicle is different according to a vehicle kind (e.g., full-sized type, mid-sized type, and compact type), and is proportional to a total traveling distance that a corresponding vehicle drives. For example, when a full-sized vehicle of 3000 cc or more drives a long distance, a carbon discharge amount remarkably increases, and when a compact vehicle of 1500 cc or less drives a short distance, a carbon discharge amount remarkably reduces. A carbon discharge amount has different discharge references according to a vehicle model (passenger car, passenger van, and truck) and fuel used, and thus the carbon discharge amount may be calculated with reference to a carbon dioxide discharge coefficient table of all vehicles.

Table 2 is a carbon dioxide discharge coefficient table.

TABLE 2

| | | | Discharge coefficient |
|---|---|---|---|
| Vehicle type | | Fuel | [CO²/km] |
| Passenger vehicle | Sub-compact | Gasoline | 137.8 |
| | Compact | | 180.9 |
| | Mid-size | | 212.9 |
| | Full-sized | | 235.7 |
| Taxi | | LPG | 231.0 |
| Passenger van | Compact | Gasoline | 251.7 |
| | | Light diesel | 243.3 |
| | | LPG | 190.2 |
| | Mid-size | Light diesel | 315.1 |
| | Full-sized | Light diesel | 1382.4 |
| Truck | Compact | Gasoline | 247.3 |
| | | Light diesel | 245.5 |
| | | LPG | 187.9 |
| | Mid-size | Light diesel | 334.9 |
| | Full-sized | Light diesel | 1388.2 |

A carbon dioxide discharge coefficients according to Table 2 are values that are determined through actual measurement by the Korean National Institute of Environmental Research, and the present invention is not limited thereto.

The insurance management server 200 calculates a carbon discharge coefficient value occurring while driving the vehicle using Table 1 based on information about a vehicle kind that is included in customer information and vehicle driving information, and stores this as a fifth variable E′.

As described above, when values of first to fifth variables A′-E′ are acquired based on collected vehicle driving information, the insurance management server 200 calculates an environmentally-friendliness driving index based on the first to fifth variables and weight values W1, W2′, W3′, W4′, and W5′ that an insurance company defines (S910).

An environmentally-friendliness driving index according to an exemplary embodiment of the present invention may be calculated as follows.

Environmentally-friendliness driving index=(A′×W1′)+(B′×W2′)+(C′×W3′)+(D′×E′×W4′) (Equation 2)

Herein, A′ represents the number of sudden accelerations and sudden starts as the first variable, B′ represents the number of sudden deceleration and sudden braking events as the second variable, C′ represents the idle running time as the third variable, D′ represents the total driving distance as the fourth variable, and E′ represents the carbon dioxide discharge coefficient as the fifth variable. For example, a weight value may be given as W1′=0.1, W2′=0.2, W3′=0.2, and W4′=0.6.

As described above, values of the first to fifth variables A′-E′ for calculating the environmentally-friendliness driving index are acquired based on vehicle driving information, and the environmentally-friendliness driving index is calculated as in Equation 2 using the preset weight values W1, W2′, W3′, W4′, and W5′ according to terms of insurance to which a customer subscribes.

Thereafter, the insurance management server 200 sets the environmentally-friendliness driving index grade based on the calculated environmentally-friendliness driving index (S920).

The environmentally-friendliness driving index is a relative value of collected and analyzed vehicle driving information that is related to safety and is collected from the vehicle information collection apparatus 100, and reflects a weight value that an insurance company provides, and in an exemplary embodiment of the present invention, the environmentally-friendliness driving index range is defined and a grade is set according to the environmentally-friendliness driving index range. For example, the environmentally-friendliness driving index previously sets a grade of 1 to 10 according to a minimum value and a maximum value thereof, and a grade of the calculated environmentally-friendliness driving index is determined and set.

Thereafter, the insurance management server 200 applies a premium or discount to an insurance bill according to an environmentally-friendliness driving index grade corresponding to a customer (S930). For example, as the environmentally-friendliness driving index grade advances when it represents that environmentally-friendly driving is not performed, if the environmentally-friendliness driving index grade is grade 1, a 10% discount of an insurance bill may be applied, if the environmentally-friendliness driving index grade is grade 3, a 7% discount of an insurance bill may be applied, while if the environmentally-friendliness driving index grade is grade 5, a 5% discount of an insurance bill may be applied. However, if the environmentally-friendliness driving index grade is grade 6, a 5% premium of an insurance bill may be applied, if the environmentally-friendliness driving index grade is grade 8, a 7% premium of an insurance bill may be applied, and if the environmentally-friendliness driving index grade is grade 10, a 10% premium of an insurance bill may be applied.

According to such an exemplary embodiment of the present invention, a data item that is specialized in various insurance services (e.g., PAYD, day of the week, environmentally-friendliness, and safe driving) is easily collected from a vehicle through a vehicle information collection apparatus, and as the vehicle information collection apparatus transmits only summary data for application of a service to an insurance management server through a communication network such as a wireless network or 3G network, an insurance-related service based on collected data can be efficiently provided even while largely reducing a data amount that is interlocked between the apparatus and the server. An insurance company can suggest a function, a structure, and an initialization scenario of a vehicle OBD collection apparatus for effectively operating the insurance products together with launching of various insurance products to the market, quickly provide vehicle driving information that a consumer wants using this, and easily and quickly construct and operate new insurance having competitive power based on the vehicle driving information.

According to an exemplary embodiment of the present invention, by collecting vehicle driving information by specializing in various insurance services, by processing the collected information into summary data for applying to the service, and by transmitting the summary data to an insurance management server through a communication network such as a third generation (3G) network or a wireless network, even while reducing an interlocked data amount, an efficient insurance related service can be provided.

Further, by efficiently initializing an apparatus that collects vehicle driving information according to insurance to which a customer subscribes, data that is specialized in an insurance service can be collected.

In addition, by analyzing vehicle driving information, by forming contents of safe driving or environmentally-friendly driving into an index, by comparing the index with service subscription conditions that are suggested in insurance terms, and by using the index as basic data for a discount or premium, a more specialized insurance related service can be provided to a user.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from a description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of managing vehicle insurance by connecting to a vehicle information collection apparatus that is mounted in a vehicle, the method comprising:
collecting vehicle driving information comprising data corresponding to a kind of insurance to which a user of the vehicle subscribes by initializing the vehicle information collection apparatus;
receiving vehicle driving information that is collected from the vehicle information collection apparatus;
calculating a safety driving index or an environmentally-friendliness driving index according to a kind of insurance to which the user subscribes based on the received vehicle driving information; and
managing insurance to which the user subscribes based on the calculated safety driving index or environmentally-friendliness driving index.

2. The method of claim 1, wherein the collecting of vehicle driving information comprises:
receiving an initialization request message from the vehicle information collection apparatus;
determining a kind of data to collect according to a kind of insurance to which the user of the vehicle subscribes; and
generating a terminal initialization message comprising the determined data kind and transmitting the terminal initialization message to the vehicle information collection apparatus.

3. The method of claim 1, wherein the collecting of vehicle driving information comprises:
receiving an initialization request message comprising an identification number of the vehicle information collection apparatus that the terminal acquires by communicating with the vehicle information collection apparatus from the terminal of a user of the vehicle;
determining a kind of data to collect according to a kind of insurance to which the vehicle user subscribes; and
generating a terminal initialization message comprising the determined data kind and transmitting the terminal initialization message to one of the user terminal and the vehicle information collection apparatus.

4. The method of claim 2, wherein the determining of a kind of data comprises:
determining whether the vehicle driver has subscribed to one of a safety index-based insurance service and an environmentally-friendliness driving index-based insurance service; and
determining a data kind to collect according to the determined insurance service.

5. The method of claim 2, wherein the initialization request message comprises a serial number, which is an identification number of the vehicle information collection apparatus, and a mounting date when the vehicle information collection apparatus is mounted in the vehicle.

6. The method of claim 2, wherein the terminal initialization message comprises a name of the user, vehicle information, a kind of insurance to which the user subscribes, and a kind of vehicle driving information data to collect for corresponding insurance.

7. The method of claim 1, further comprising:
when the user subscribes to a safe driving-based insurance service,
calculating a first variable, which is a number of sudden accelerations, a second variable, which is a number of sudden braking events, a third variable, which is a number of long time driving events, a fourth variable, which is a number of speed limit violations, and a fifth variable, which is an excess traveling distance based on the vehicle driving information;
giving respective different weight values to at least one of the first to fifth variables; and
calculating a safe driving index based on the first variable to the fifth variable in which the weight values are given.

8. The method of claim 7, wherein in the calculating of a safe driving index,
a condition of the safe driving index=A+B+(C×W1)+(D×W2)+(ENV3) is used, where A is a first variable, B is a second variable, C is a third variable, D is a fourth variable, E is a fifth variable, W1 is a weight value of the first variable, W2 is a weight value of the second variable, and W3 is a weight value of the third variable.

9. The method of claim 7, wherein the managing of insurance comprises:
setting a safe driving index grade based on the calculated safe driving index; and
discounting an insurance bill of an insurance service or adding a premium of an insurance bill of an insurance service to which the user subscribes according to the preset safe driving index grade.

10. The method of claim 1, further comprising:
when the user subscribes to an environmentally-friendliness driving-based insurance service,
calculating a first variable, which is a number of sudden accelerations and a number of sudden starts, a second variable, which is a number of sudden decelerations and a number of sudden braking events, a third variable, which is an idle running time, a fourth variable, which is a total traveling distance, and a fifth variable, which is a carbon dioxide discharge coefficient based on the vehicle driving information;
giving respective different weight values to at least one of the first variable to the fifth variable; and
calculating an environmentally-friendliness driving index based on the first variable to the fifth variable to which the weight values are given.

11. The method of claim 10, wherein in the calculating of an environmentally-friendliness driving index, a condition of the environmentally-friendliness driving index=(A′×W1′)+(B′×W2′)+(C′×W3′)+(D′×E′×W4′) is used, where A′ is a first variable, B′ is a second variable, C′ is a third variable, D′ is a fourth variable, E′ is a fifth variable, W1′ is a weight value of the first variable, W2′ is a weight value of the second variable, W3′ is a weight value of the third variable, and W4′ is a weight value of the fourth variable.

12. The method of claim 10, wherein the managing of insurance comprises:
setting an environmentally-friendliness driving index grade based on the calculated environmentally-friendliness driving index; and
discounting an insurance bill of an insurance service or adding a premium of an insurance bill of an insurance service to which the user subscribes according to the preset environmentally-friendliness driving index grade.

13. The method of claim 1, wherein the vehicle driving information comprises at least one of: a driving start time, which is a time at which the vehicle is started by a driver and driving is started; a driving stop time, which is a time at which the vehicle is turned off by the driver; an average speed, which is an average value of speed while the vehicle is being driven; a highest speed of a vehicle while the vehicle is being driven; an overspeed driving time, which is a time when the vehicle exceeds a speed limit that is determined for a service while the vehicle is being driven; a long time driving time, which is a driving time that exceeds a long time driving time that is determined for the service while the vehicle is being driven; a driving distance, which is a total distance while the vehicle is being driven in one session; a number of sudden starts, which is the number of times the vehicle accelerates at a rate of speed of a preset value or more when the vehicle starts from a stop; a number of sudden braking events, which is the number of times the vehicle decelerates at a rate of speed of a preset value or more while the driver uses a brake; a number of sudden accelerations, which is the number of times the vehicle suddenly accelerates at a rate of speed of a preset value or more while the vehicle is being driven; a brake use time, which is a time during which the brake is used while the vehicle is being driven; and global positioning system (GPS) information representing a history of GPS values of a region the vehicle moves in while it is being driven.

14. A system that manages vehicle insurance by connecting to a vehicle information collection apparatus that is mounted in a vehicle, the system comprising:
a customer insurance information management unit that manages information about insurance to which a user subscribes, wherein the information comprises information about an insurance kind comprising a driving-based insurance service and an environmentally-friendliness driving-based insurance service;
an initialization processor that enables collection of vehicle driving information comprising data corresponding to a kind of insurance to which the vehicle user subscribes by initializing the vehicle information collection apparatus according to a received initialization request message;
a vehicle driving information receiving unit that receives vehicle driving information that is collected from the vehicle information collection apparatus;
a safety driving index calculation unit that calculates a safety driving index according to a kind of insurance to which the user subscribes based on the received vehicle driving information; and
a safety driving index calculation unit that calculates an environmentally-friendliness driving index according to a kind of insurance to which the user subscribes based on the received vehicle driving information.

15. The system of claim 14, wherein the initialization processor determines a kind of data to collect according to a kind of insurance to which a user of the vehicle subscribes, generates a terminal initialization message comprising a kind of the determined data, and transmits the terminal initialization message to the vehicle information collection apparatus, when receiving the initialization request message.

16. The system of claim 14, wherein the safety driving index calculation unit uses a condition of the safety driving index=A+B+(C×W1)+(D×W2)+(E/W3),
where A is a first variable, which is a number of sudden accelerations, B is a second variable, which is a number of sudden braking events, C is a third variable, which is a number of long time driving events, D is a fourth variable, which is a number of speed limit violations, E is a fifth variable, which is an excess traveling distance, W1 is a weight value of the first variable, W2 is a weight value of the second variable, and W3 is a weight value of the third variable.

17. The system of claim 14, wherein the environmentally-friendliness driving index calculation unit uses a condition of the environmentally-friendliness driving index=(A′×W1′)+(B′×W2¹)+(C1×W3′)+(D′×E′×W4′),
where A′ is a first variable, B′ is a second variable, C′ is a third variable, D′ is a fourth variable, E′ is a fifth variable, W1′ is a weight value of the first variable, W2′ is a weight value of the second variable, W3′ is a weight value of the third variable, and W4′ is a weight value of the fourth variable.

18. The system of claim 14, wherein the safe driving index calculation unit sets a safe driving index grade based on the calculated safe driving index and according to the preset safe driving index grade, and discounts an insurance bill of an insurance service or adds a premium of an insurance bill of an insurance service to which the user subscribes according to the preset safe driving index grade, and
the environmentally-friendliness driving index calculation unit sets an environmentally-friendliness driving index grade based on the calculated environmentally-friendliness driving index, and discounts an insurance bill of an insurance service or adds a premium of an insurance bill of an insurance service to which the user subscribes according to the preset environmentally-friendliness driving index grade.
